(19) United States
(12) Patent Application Publication
(10) Pub. No.: US 2019/0176722 A1
(43) Pub. Date: Jun. 13, 2019

(54) BI-STABLE FLAT SPRING CLIPPING DEVICE

(71) Applicant: International Truck Intellectual Property Company, LLC, Lisle, IL (US)

(72) Inventor: Gregory John Saele, Itasca, IL (US)

(73) Assignee: International Truck Intellectual Property Company, LLC, Lisle, IL (US)

(21) Appl. No.: 15/838,622

(22) Filed: Dec. 12, 2017

(51) Int. Cl. B60R 16/02; F16M 13/02; B62D 65/02; F16B 9/02

(52) U.S. Cl. CPC B60R 16/0215; F16B 9/023; B62D 65/02; F16M 13/02

(57) ABSTRACT

A method and apparatus for attaching a bundle of wiring harnesses, air lines, hoses, tubes, cables, fuel lines, and the like to the frame or body of a vehicle or other machine uses a clipping device with a bi-stable flat spring having two states, a metastable flat state and a stable coiled state. The clipping device is preassembled to the vehicle or other machine with the bi-stable flat spring in its flat metastable state using a mounting feature. The bundle is pressed against the bi-stable flat spring, causing it to transition from the flat state to the coiled state, thereby encircling and retaining the bundle to the vehicle. The clipping device may be provided with a secondary locking feature and/or an initial flat state retaining feature.

### BACKGROUND

Embodiments described herein generally relate to an apparatus and method for attaching wiring harnesses, air lines, hoses, tubes, cables, fuel lines, and the like to the frame or body of a vehicle or other machine using a bi-stable flat spring having a mounting feature.

### RELATED ART

Ground traveling vehicles possess a large number of wiring harnesses, air lines, hoses, tubes, cables, fuel lines, and the like, which must be carefully clipped and routed from one component to another, in order to avoid chaffing, interference with vehicle componentry, or exposure to adverse environmental factors, such as high temperatures. In order to accomplish this, vehicle manufacturers utilize a tremendous number and variety of plastic and metal clips, plastic tie straps, strap-locks, retainers, brackets, standoffs, plastic saddles, and/or fasteners in order to ensure that the wires, lines, hoses, tubes, and/or cables remain in their proper designed routing positions. Commonly, these clips, plastic tie straps, retainers, saddles, brackets, and etcetera are attached to a vehicle component such as a frame or body part in a time consuming process requiring several manual steps.

For example, a P-clip must be chosen to match the size of the bundle of wires, lines, hoses, tubes, and/or cables. Then the P-clip must be positioned around the bundle at a location matching a mounting hole or stud. The P-clip mounting hole must then be positioned over the mounting stud, or a fastener placed through the P-clip mounting hole and into the mounting hole on the vehicle. A fastener must then be threaded through the hole, or over the stud, and tightened to a proper torque. Each of these steps requires dexterity, repetitive and possibly injurious motion, and costly assembly time. Similarly, the use of plastic tie straps also requires potentially injurious repetitive motion, and commonly requires the use of plastic saddles to keep lines and wires from chaffing on sharp metal edges and brackets. The necessity for plastic saddles further adds to vehicle cost and assembly time. Furthermore, if the wrong P-clip or other clip, plastic tie strap, retainer, bracket, and etcetera is chosen, or if the P-clip or plastic tie strap is improperly tightened, the clip or tie strap may dig into, pinch, or otherwise improperly restrict the wires, lines, hoses, tubes, and/or cables. Avoiding this requires that a plethora of clips, plastic tie straps, retainers, brackets, and etcetera be provided, which adds to the cost of the vehicle. P-clips in particular have the disadvantage of being a fixed diameter, so that one part cannot accommodate variations in bundle size. Also, P-clips often are not as mechanically robust as plastic tie straps. In order to be flexible enough to be easy to assemble, they are generally of a very thin gauge material, so in some cases are lacking in sufficient strength.

Accordingly, there is an unmet need for an apparatus and method of clipping and routing wiring harnesses, air lines, hoses, tubes, cables, fuel lines, and the like while minimizing the number and variety of plastic and metal clips, plastic tie straps, strap-locks, retainers, brackets, standoffs, plastic saddles, and/or fasteners, and while further minimizing the number of manual, time-consuming, and repetitive steps involved in assembly.

### SUMMARY

According to one embodiment, a system for attaching linear elements to a vehicle includes at least one bi-stable flat spring clipping device. The at least one bi-stable flat spring clipping device includes at least one bi-stable flat spring characterized by being metastable in a flat state and stable in a coiled state. The at least one bi-stable flat spring has at least one mounting feature.

According to another embodiment, a method for attaching at least one linear element to a vehicle comprises the steps of: providing at least one bi-stable flat spring clipping device having at least one bi-stable flat spring characterized by being metastable in a flat state and stable in a coiled state, and having at least one mounting feature. The at least one bi-stable flat spring clipping device is attached to the vehicle using the at least one mounting feature with the at least one bi-stable flat spring in the metastable flat state. A threshold force is applied to the at least one bi-stable flat spring causing the at least one bi-stable flat spring to transition from the metastable flat state to the stable coiled state while encircling the at least one linear element.

### DESCRIPTION OF THE DRAWINGS

FIG. 1 is an isometric view of an embodiment of the Bi-Stable Flat Spring Clipping Device in a flat state, as described herein;

FIG. 2 is an isometric view of an embodiment of the Bi-Stable Flat Spring Clipping Device in a coiled state, as described herein;

FIGS. 3 and 4 are top views of embodiments of Bi-Stable Flat Spring Clipping Devices in the flat state, as described herein;

FIG. 5 is a side view of an embodiment of the Bi-Stable Flat Spring Clipping Device attached to the frame of a vehicle and in the flat state, with a bundle of linear elements to be attached thereto, as described herein;

FIG. 6 is a side view of an embodiment of the Bi-Stable Flat Spring Clipping Device attached to the frame of a vehicle and in the coiled state, engaging a bundle of linear elements, as described herein;

FIG. 7 is a front view of an embodiment of the Bi-Stable Flat Spring Clipping Device attached to the frame of a vehicle and in the coiled state, engaging a bundle of linear elements, as described herein;

FIG. 8 is a side view of another embodiment of the Bi-Stable Flat Spring Clipping Device attached to the frame of a vehicle and in the coiled state, engaging a bundle of linear elements, as described herein;

FIG. 9 is a side view of another embodiment of the Bi-Stable Flat Spring Clipping Device attached to the frame of a vehicle and in the coiled state, engaging a bundle of linear elements, as described herein;

FIG. 10 is a top view of another embodiment of the Bi-Stable Flat Spring Clipping Device in the flat state, as described herein;

FIG. 11 is a side view of the embodiment of the Bi-Stable Flat Spring Clipping Device of FIG. 10 in the coiled state, as described herein;

FIG. 12 is a top view of another embodiment of the Bi-Stable Flat Spring Clipping Device in the flat state, as described herein;

FIG. 13 is a side view of the embodiment of the Bi-Stable Flat Spring Clipping Device of FIG. 12 in the coiled state, as described herein;

FIG. 14 is a top view of another embodiment of the Bi-Stable Flat Spring Clipping Device in the flat state, as described herein;

FIG. 15 is a side view of the embodiment of the Bi-Stable Flat Spring Clipping Device of FIG. 14 in the coiled state, as described herein;

FIG. 16 is a top view of another embodiment of the Bi-Stable Flat Spring Clipping Device in the flat state, as described herein;

FIG. 17 is a side view of another embodiment of the Bi-Stable Flat Spring Clipping Device attached to the frame of a vehicle and in the flat state, with a bundle of linear elements to be attached thereto, as described herein;

FIG. 18 is a side view of the embodiment of the Bi-Stable Flat Spring Clipping Device of FIG. 17 attached to the frame of a vehicle and in the coiled state, engaging a bundle of linear elements, as described herein;

FIG. 19 is a side view of another embodiment of the Bi-Stable Flat Spring Clipping Device attached to the frame of a vehicle and in the flat state, with a bundle of linear elements to be attached thereto, as described herein;

FIG. 20 is a side view of the embodiment of the Bi-Stable Flat Spring Clipping Device of FIG. 19 attached to the frame of a vehicle and in the coiled state, engaging a bundle of linear elements, as described herein;

FIG. 21 is a side view of another embodiment of the Bi-Stable Flat Spring Clipping Device attached to the frame of a vehicle and in the flat state, with a bundle of linear elements to be attached thereto, as described herein;

FIG. 22 is a side view of the embodiment of the Bi-Stable Flat Spring Clipping Device of FIG. 21 attached to the frame of a vehicle and in the coiled state, engaging a bundle of linear elements, as described herein;

FIG. 23 is a side view of another embodiment of the Bi-Stable Flat Spring Clipping Device attached to the frame of a vehicle and in the flat state, with a bundle of linear elements to be attached thereto, as described herein;

FIG. 24 is a side view of the embodiment of the Bi-Stable Flat Spring Clipping Device of FIG. 23 attached to the frame of a vehicle and in the coiled state, engaging a bundle of linear elements, as described herein; and

FIG. 25 is a section view of the embodiment of the Bi-Stable Flat Spring Clipping Device of FIG. 1 taken at plane “a”, as described herein.

### DETAILED DESCRIPTION

Embodiments described herein relate to a bi-stable flat spring clipping device having a mounting feature that is used to attach wiring harnesses, air lines, hoses, tubes, cables, fuel lines, and the like to the frame or body of a vehicle or other machine, in order to provide positive retention and routing, and to avoid chaffing, interference with vehicle or machine componentry, or exposure to adverse environmental factors, such as high temperatures. The bi-stable flat spring is a spring device that has two states, a metastable flat state and a stable coiled state. Such bi-stable flat springs are sometimes used as the basis for body ornamentation, in which trivial application they may be referred to as “slap bracelets.” When a bi-stable flat spring is partially bent from the flat state, which is in fact a metastable state, it releases stored energy by continuing to transition completely from the flat state to the coiled state. The Bi-Stable Flat Spring Clipping Device employs this characteristic of bi-stable flat springs to reduce part complexity and variation, and to minimize assembly time and repetitive motion in attaching wiring harnesses, air lines, hoses, tubes, cables, fuel lines, and the like to the frame or body of a vehicle or other machine.

The Bi-Stable Flat Spring Clipping Device is preassembled to the frame or body of the vehicle or other machine in its flat metastable state using the mounting feature. The mounting feature may simply be one or more threaded or non-threaded holes to be placed over a stud or bolt, or may be any other kind of fastener, including but not limited to push-nuts, speed nuts, rivets, snaps, pins, clips, clasps, fir tree clips, bonding such as glues, epoxies, and other adhesives, magnets, and hook and loop. Once the Bi-Stable Flat Spring Clipping Device is preassembled to the frame or body, directly or by way of another component such as a bracket, a bundle of wiring harnesses, air lines, hoses, tubes, cables, fuel lines, and the like may simply be pushed against the bi-stable flat spring, which then coils itself around the bundle. No tie straps need to be threaded or tightened, as the bi-stable flat spring adjusts itself to the diameter of the bundle, and provides a continuous tightening force due to the spring bias towards a tighter coil. Therefore, repetitive motion and manual production steps are minimized, and assembly speed is increased.

Because tension of the coil around the bundle is controlled by the spring rate of the bi-stable flat spring, the amount of clamp load on the bundle of wiring harnesses, air lines, hoses, tubes, cables, fuel lines, and the like is not dependent upon the tool operator, and can be designed into the bi-stable flat spring in order to avoid compromising the integrity of the bundle being held in position by the coil. Also, once coiled around the bundle, the extra width of the bi-stable flat spring helps to protect the bundle from chaffing against itself and any fasteners used to hold it in place. The bi-stable flat spring of the Bi-Stable Flat Spring Clipping Device is designed to resist uncoiling and to be sufficiently strong to support the weight of the bundle without risk of relaxing or moving under all operating conditions. At the same time, the bi-stable flat spring is designed not to exceed the amount of compression that the bundle can withstand without deforming, pinching off, or otherwise improperly restricting the wires, lines, hoses, tubes, and/or cables. Furthermore, the bi-stable flat spring is designed to be releasable by hand for service, and to have a sufficient amount of threshold force necessary to transition the bi-stable flat spring from the flat state to the coiled state so that the bi-stable flat spring remains in the flat state until the bundle is pressed against it during assembly, yet does not require excessive force by the assembler in order to trip the bi-stable flat spring from the flat state to the coiled state. Additionally, the bi-stable flat spring is designed so that an amount of energy released in the transition from the flat state to the coiled state is not sufficient to unduly risk injury to the assembler.

In cases where the coiled spring force of the bi-stable flat spring is insufficient to support the weight of the bundle of wires, lines, hoses, tubes, and/or cables, a secondary locking feature may be employed to lock the Bi-Stable Flat Spring Clipping Device in the desired coiled position. The secondary locking feature may be a tab or clip that folds over to lock the coiled bi-stable flat spring, which tab or clip may itself be a bi-stable spring element. Alternately, the secondary locking feature may be interlocking edges, saw-tooth edges, a friction element molded into the spring, one or more patches of hook and loop fastener, another such mechanism. In this way, the Bi-Stable Flat Spring Clipping Device is not permanently locking, so it can be undone and reused in service.

In cases in which sufficient stability in the flat state cannot be achieved without requiring excessive force to trip the bi-stable flat spring from the flat state to the coiled state, or without releasing an excessive amount of potential energy in doing so, a flat state retaining feature may be employed to maintain the bi-stable flat spring in the flat state until it needs to be coiled. An exemplary non-limiting embodiment may utilize a release pin to keep the bi-stable flat spring in the flat state. The release pin would be pulled out by the assembler in order to coil the bi-stable flat spring, and the release pin is then discarded. Another exemplary non-limiting embodiment uses an over molded plastic or other material feature that holds the bi-stable flat spring in the flat state, but is easily broken when an operator deforms the bi-stable flat spring into the coiled state, or can be easily peeled off to release the bi-stable flat spring into the coiled state.

The Bi-Stable Flat Spring Clipping Device may be manufactured from steel, or stainless steel for corrosion resistance, or from any other material having the proper spring characteristics. Because some hoses and wires are sensitive to abrasion by sharp edges, or are sensitive to contact with electrically conductive materials, in such applications the edges or entire surface of the Bi-Stable Flat Spring Clipping Device are coated with a plastic over mold, rubber coating, sleeve, or other such protective barrier.

Embodiments of the bi-stable flat spring clipping device are able to provide positive retention and routing while reducing part complexity and variation and minimizing assembly time and repetitive motion, at least in part by utilizing a bi-stable flat spring that automatically coils itself around a bundle of wiring harnesses, air lines, hoses, tubes, cables, fuel lines, and the like with a minimum of required dexterous motion by the assembly line operator. The bi-stable flat spring of the bi-stable flat spring clipping device resists uncoiling without exceeding the amount of compression that the bundle can withstand without deforming, pinching off, or otherwise improperly restricting the wires, lines, hoses, tubes, and/or cables. The bi-stable flat spring clipping device is reusable in service.

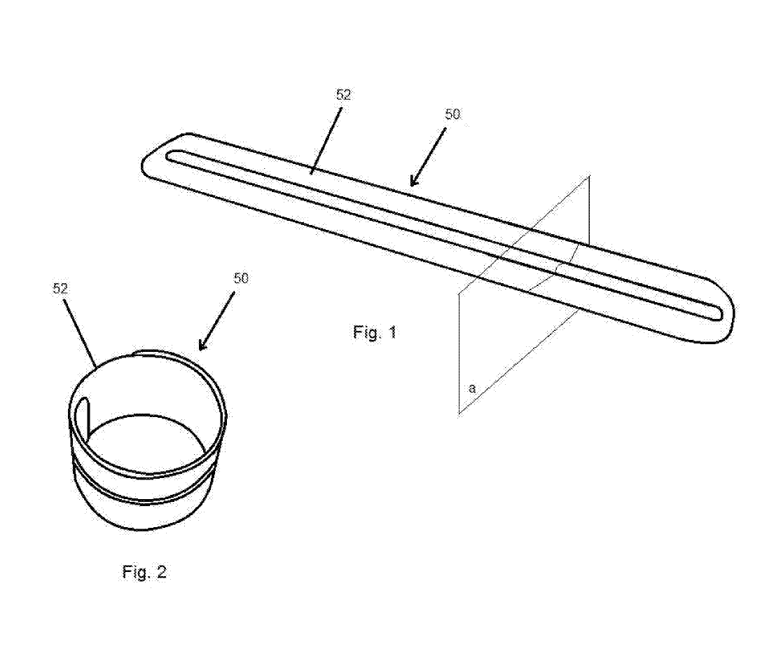

Referring now to FIGS. 1 and 2, isometric views of embodiments of a bi-stable flat spring 52 of a bi-stable flat spring clipping device 50 are shown. In FIG. 1, the bi-stable flat spring 52 is shown in the flat state, which is in fact a metastable state. In other words, when the bi-stable flat spring 52 is bent at any point along its length, the internal tension forces keeping the bi-stable flat spring 52 flat are overcome by the internal tension forces that pull the bi-stable flat spring 52 into a coil, so that the bi-stable flat spring 52 rapidly and progressively assumes the coiled state, as shown in FIG. 2. Stated more accurately, the bi-stable flat spring 52 assumes a flatter cross section, reducing the moment of inertia about the neutral axis, so that the bi-stable flat spring 52 undergoes a progressive buckling driven by its own internal tensile forces, which are in turn relieved by the bi-stable flat spring 52 assuming the coiled state.

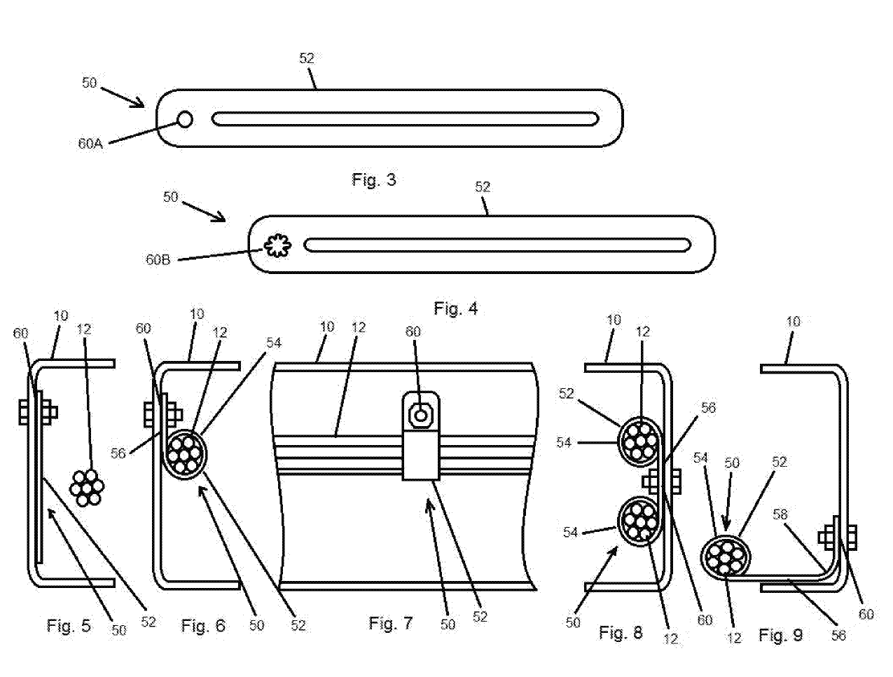

Turning now to FIGS. 3 and 4, top views of additional embodiments of bi-stable flat spring clipping devices 50 are shown. The bi-stable flat spring clipping devices 50 are each made of a bi-stable flat spring 52 having a mounting feature 60. The mounting feature 60 of the bi-stable flat spring clipping device 50 in FIG. 3 is a simple hole 60A to be used with a mounting stud, nut and bolt fastener, rivet, fir tree push-in type fastener, or other type of fastener. The mounting feature 60 of the bi-stable flat spring clipping device 50 in FIG. 4 is an interference hole 60B, which is designed to be pushed over a stud (not shown) and to remain in position due to the interference fit of the star or asterisk shape of the hole 60B. Other types of fasteners contemplated to be used include but are not limited to push-nuts, speed nuts, rivets, snaps, pins, clips, clasps, fir tree clips, bonding such as glues, epoxies, and other adhesives, magnets, and hook and loop.

FIGS. 5, 6, and 7 show another embodiment of the bi-stable flat spring clipping device 50 in use. The bi-stable flat spring clipping device 50 again is made of a bi-stable flat spring 52 having a mounting feature 60, in this case a simple hole used with a conventional nut and bolt type fastener. The embodiment of the bi-stable flat spring clipping device 50 shown in FIGS. 5, 6, and 7 may have a coiling section 54 and a non-coiling section 56. The coiling section 54 is characterized by being bi-stable between the flat state and the coiled state, whereas the non-coiling section 56 is characterized by being stable only in the flat state. The bi-stable flat spring clipping device 50 is shown attached to a vehicle chassis or frame 10, which is shown in an end view in FIGS. 5 and 6, and in a side view in FIG. 7. In FIG. 5, a bundle of linear elements 12, such as wiring harnesses, air lines, hoses, tubes, cables, fuel lines, and the like, are prepared to be attached to the bi-stable flat spring clipping device 50. In FIG. 6 and FIG. 7, the linear element bundle 12 has been pressed against the bi-stable flat spring 52 of the bi-stable flat spring clipping device 50, which has, as a result of the pressure and slight bending from the pressure of the linear element bundle 12 being pressed against it, assumed the coiled position and thereby positively retained the linear element bundle within the coil.

FIG. 8 shows an alternate embodiment of the bi-stable flat spring clipping device 50, which again is provided with a bi-stable flat spring 52 having a mounting feature 60. The bi-stable flat spring clipping device 50 is again shown attached to a vehicle chassis or frame 10 using a conventional nut and bolt fastener. The alternate embodiment of the bi-stable flat spring clipping device 50 shown in FIG. 8 has two coiling section 54 at either end, with the non-coiling section 56 having the mounting feature 60 in between. In this way, the alternate embodiment of the bi-stable flat spring clipping device 50 can hold two separate linear element bundles 12.

FIG. 9 shows another embodiment of the bi-stable flat spring clipping device 50, which again is provided with a bi-stable flat spring 52 having a mounting feature 60. The bi-stable flat spring clipping device 50 is again shown attached to a vehicle chassis or frame 10 using a conventional nut and bolt fastener. The alternate embodiment of the bi-stable flat spring clipping device 50 shown in FIG. 9 has a coiling section 54, a non-coiling section 56, and a formed section 58. In this way, the bi-stable flat spring clipping device 50 holds the linear element bundle 12 at a convenient position within the coiling section 54 for assembly and routing.

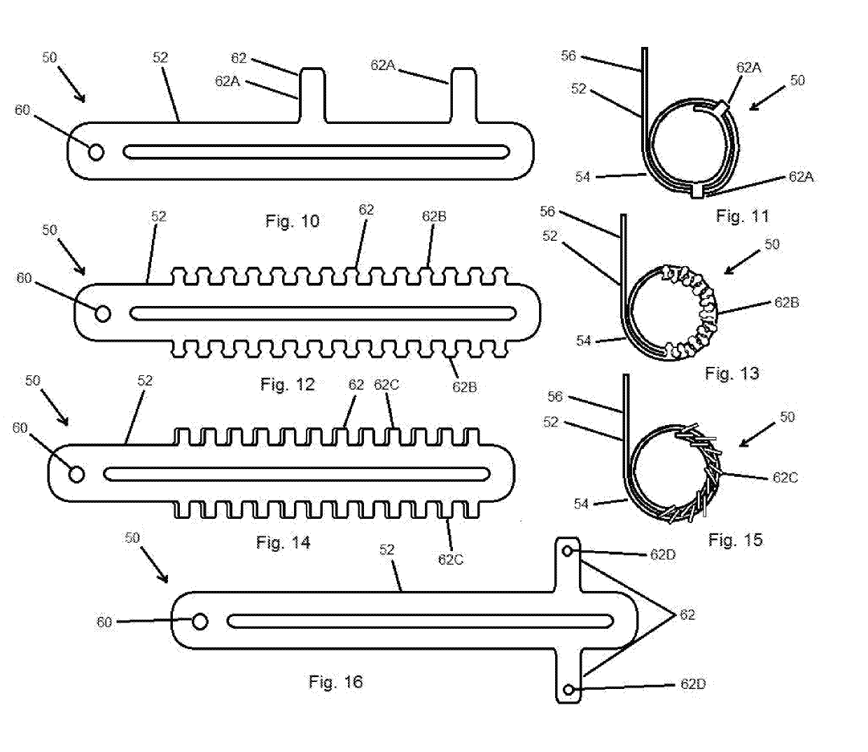

FIGS. 10 through 16 show a series of embodiments of the bi-stable flat spring clipping device 50 having a secondary locking feature or features 62. The bi-stable flat spring clipping devices 50 are again made of bi-stable flat springs 52 having coiling sections 54, non-coiling sections 56, and mounting features 60. The secondary locking feature or features 62 are provided for situations where the coiling force of the bi-stable flat spring 52 is insufficient to support the weight of the linear element bundle 12. In FIGS. 10 and 11, the secondary locking features 62 are tabs or clips 62A. Once the coiling section 54 of the bi-stable flat spring 52 has coiled around the linear element bundle 12 (not shown), the tabs or clips 62A are folded over the coils of the bi-stable flat spring 52, thereby preventing it from uncoiling. Further, the tabs or clips 62A may themselves be bi-stable, so that they transition from a metastable open state to a stable closed state. Alternately, the tabs or clips 62A may simply be bendable, so that they are bent or crimped into the proper closed position. A similar embodiment of the bi-stable flat spring clipping device 50 is shown in FIG. 16, wherein the tabs are provided with tab connections 62D, such as snaps or other interlocking features.

In FIGS. 12 and 13, the secondary locking features 62 are interlocking edges 62B. Once the coiling section 54 of the bi-stable flat spring 52 has coiled around the linear element bundle 12 (not shown), a sufficient number of the interlocking edges 62B are pressed into an interlocking position, where the approximately mushroom shape of the interlocking edges 62B prevents them from readily disengaging. In FIGS. 14 and 15, the secondary locking features 62 are saw-tooth edges 62C, which are twisted slightly out of the plane of the bi-stable flat spring 52. In this way, when the coiling section 54 coils around the linear element bundle 12 (not shown), the saw-tooth edges 62C slide over one another in the coiling direction, but catch on one another in the uncoiling direction, thereby preventing the bi-stable flat spring clipping device 50 from disengaging from the linear element bundle 12.

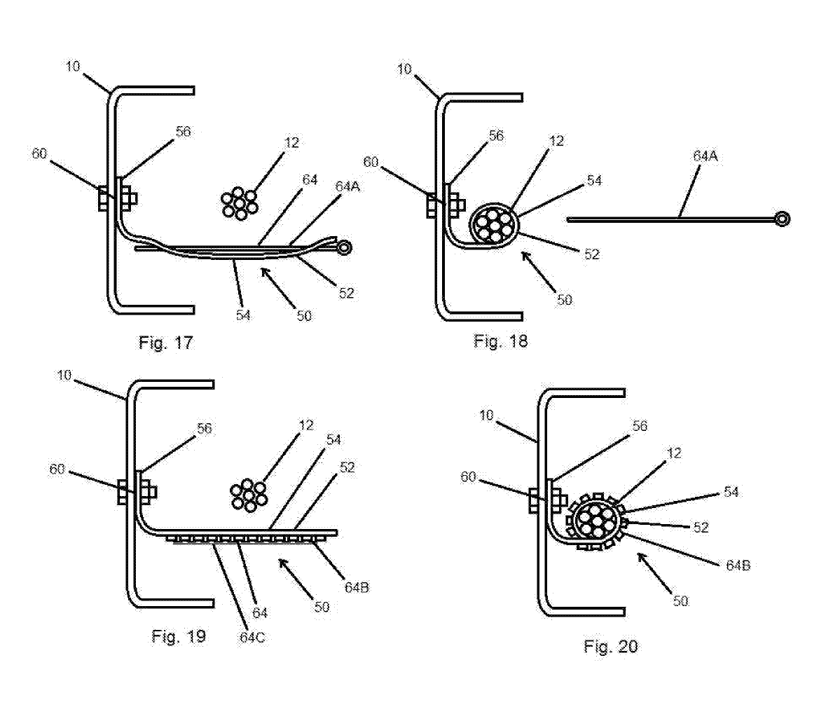

Turning now to FIGS. 17 through 20, further embodiments of the bi-stable flat spring clipping device 50 are shown having flat state maintaining features 64. The bi-stable flat spring clipping devices 50 are again each provided with a bi-stable flat spring 52 having a coiling section 54, a non-coiling section 56, and a mounting feature 60. The flat state maintaining feature 64 holds the coiling section 54 of the bi-stable flat spring 52 in the flat state while the bi-stable flat spring clipping device 50 is attached to the vehicle chassis or frame 10, and until such time the linear element bundle 12 is placed in the proper position. This may be necessary when sufficient stability in the flat state cannot be achieved without requiring excessive force to trip the bi-stable flat spring 52 from the flat state to the coiled state, or without releasing an excessive amount of potential energy in doing so.

In FIGS. 17 and 18, the flat state maintaining feature 64 is embodied as a release pin 64A, which pierces the bi-stable flat spring 52 in two places within or near the coiling section 54. When the linear element bundle 12 is in the proper position, the release pin 64A is withdrawn from the bi-stable flat spring 52, and the coiling section 54 coils around the linear element bundle 12. In FIGS. 19 and 20, the flat state maintaining feature 64 is embodied as an overmolded frangible feature 64B or peel-away feature 64C. The overmolded frangible feature 64B functions by providing a relatively stiff series of connected segments adjacent to the coiling section 54 that holds the coiling section 54 in the flat state until the linear element bundle 12 is in the proper position. At that point, frangible connections between the series of connected segments are broken by the assembly operator pushing the coiling section 54 towards the coiled state. Alternately, the peel-away feature 64C is peeled off of the surface of the series of connected segments, thereby releasing the series of connected segments from their connected condition, and allowing the coiling section 54 to assume the coiled state.

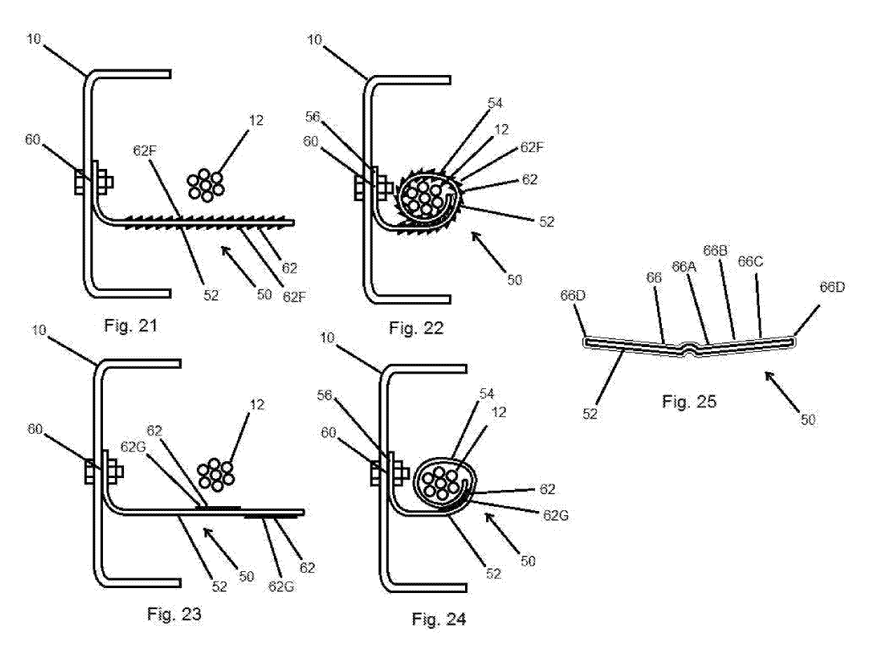

FIGS. 21 through 24 show additional embodiments of the bi-stable flat spring clipping device 50 having a secondary locking feature or features 62. The bi-stable flat spring clipping devices 50 are again made of bi-stable flat springs 52 having coiling sections 54, non-coiling sections 56, and mounting features 60. The secondary locking feature or features 62 are again provided for situations where the coiling force of the bi-stable flat spring 52 alone is insufficient to support the weight of the linear element bundle 12. In FIGS. 21 and 22, the secondary locking features 62 are embodied as interlocking surface features 62F on both surfaces of the coiling section 54, which are arranged to slide over each other in the coiling direction, but to resist sliding in the uncoiling direction, after the fashion of a ratchet mechanism. In FIGS. 23 and 24, the secondary locking features 62 are embodied as hook and loop patches 62G, and are positioned to engage one another when the coiling section 54 is in the coiled state, and to thereby resist uncoiling of the coiling section 54. In another embodiment, the secondary locking features 62 may be embodied as friction elements in place of the hook and loop patches 62G.

FIG. 25 shows an embodiment of the bi-stable flat spring clipping device 50 in an end view, thereby showing the cross section view of the bi-stable flat spring 52 as taken at plane “a” in FIG. 1. The embodiment of the bi-stable flat spring 52 in FIG. 25 is further provided with at least one protective barrier, which may further include a plastic overmold 66A, a rubber coating 66B, a sleeve 66C, and/or edge coverings 66D.

While the Bi-Stable Flat Spring Clipping Device has been described with respect to at least one embodiment, the Bi-Stable Flat Spring Clipping Device can be further modified within the spirit and scope of this disclosure, as demonstrated previously. This application is therefore intended to cover any variations, uses, or adaptations of the Bi-Stable Flat Spring Clipping Device using its general principles. Further, this application is intended to cover such departures from the present disclosure as come within known or customary practice in the art to which the disclosure pertains and which fall within the limits of the appended claims.

### REFERENCE NUMBER LISTING

| | |
|---|---|
| 10 | Vehicle chassis or frame |
| 12 | Linear element bundle |
| 14 | Tie straps |
| 16 | P-clips |
| 18 | Metal brackets |
| 20 | Plastic saddles |
| 22 | Mounting fasteners |
| 50 | Bi-stable flat spring clipping device |
| 52 | Bi-stable flat spring |
| 54 | Coiling section |
| 56 | Non-coiling section |
| 58 | Formed section |
| 60 | Mounting feature |
| 60A | Hole |
| 60B | Interference hole |
| 60C | Fir tree |
| 60D | Stud |
| 62 | Secondary locking feature |
| 62A | Tab or clip |
| 62B | Interlocking edges |
| 62C | Saw-tooth edges |
| 62D | Tab connections |
| 62E | Friction element |
| 62F | Interlocking surface feature |
| 62G | Hook and loop patches |
| 64 | Flat state maintaining feature |
| 64A | Release pin |
| 64B | Overmolded frangible feature |
| 64C | Peel-away feature |
| 66 | Protective barrier |
| 66A | Plastic overmold |
| 66B | Rubber coating |
| 66C | Sleeve |
| 66D | Edge covering |

What is claimed is:

1. A system for attaching linear elements to a vehicle, comprising:
at least one bi-stable flat spring clipping device, including at least one bi-stable flat spring characterized by being metastable in a flat state and stable in a coiled state, the at least one bi-stable flat spring having at least one mounting feature.

2. The system of claim 1, wherein:
the at least one bi-stable flat spring requiring a threshold force to be applied thereto in order to transition the at least one bi-stable flat spring from the metastable flat state to the stable coiled state, the threshold force being sufficient that the at least one bi-stable flat spring remains in the metastable flat state until at least one linear element is pressed against it during assembly.

3. The system of claim 1, further comprising:
at least one secondary locking feature arranged to selectively lock the bi-stable flat spring in the stable coiled state.

4. The system of claim 3, wherein:
the at least one secondary locking feature further comprises at least one of:
a tab or clip;
at least one interlocking edge;
at least one saw-tooth edge;
at least one friction element;
at least one patch of hook and loop fastener; and
at least one interlocking surface feature.

5. The system of claim 1, further comprising:
at least one flat state retaining feature arranged to initially maintain the bi-stable flat spring in the metastable flat state.

6. The system of claim 5, wherein:
the at least one flat state retaining feature further comprises at least one of:
a release pin;
an overmolded frangible feature; and
a peel-away feature.

7. The system of claim 1, further comprising:
the at least one bi-stable flat spring has at least one coiling section and at least one non-coiling section.

8. The system of claim 7, wherein:
the at least one bi-stable flat spring has at least one formed section.

9. A bi-stable flat spring clipping device for attaching linear elements to a vehicle, comprising:
at least one bi-stable flat spring characterized by being metastable in a flat state and stable in a coiled state, the at least one bi-stable flat spring having at least one mounting feature.

10. The bi-stable flat spring clipping device of claim 9, wherein:
the at least one bi-stable flat spring requires a threshold force to be applied thereto in order to transition the at least one bi-stable flat spring from the metastable flat state to the stable coiled state, the threshold force being sufficient that the at least one bi-stable flat spring remains in the metastable flat state until at least one linear element is pressed against it during assembly.

11. The bi-stable flat spring clipping device of claim 9, further comprising:
at least one secondary locking feature arranged to selectively lock the bi-stable flat spring in the stable coiled state.

12. The bi-stable flat spring clipping device of claim 11, wherein:
the at least one secondary locking feature further comprises at least one of:
a tab or clip;
at least one interlocking edge;
at least one saw-tooth edge;
at least one friction element;
at least one patch of hook and loop fastener; and
at least one interlocking surface feature.

13. The bi-stable flat spring clipping device of claim 9, further comprising:
at least one flat state retaining feature arranged to initially maintain the bi-stable flat spring in the metastable flat state.

14. The bi-stable flat spring clipping device of claim 13, wherein:
the at least one flat state retaining feature further comprises at least one of:
a release pin;
an overmolded frangible feature; and
a peel-away feature.

15. The bi-stable flat spring clipping device of claim 9, further comprising:
a protective barrier covering at least one surface or edge of the at least one bi-stable flat spring.

16. The bi-stable flat spring clipping device of claim 9, wherein:
the at least one bi-stable flat spring has at least one coiling section and at least one non-coiling section.

17. The bi-stable flat spring clipping device of claim 16, further comprising:
at least one formed section.

18. A method for attaching at least one linear element to a vehicle, comprising the steps of:
providing at least one bi-stable flat spring clipping device having at least one bi-stable flat spring characterized by being metastable in a flat state and stable in a coiled state, and having at least one mounting feature;
attaching the at least one bi-stable flat spring clipping device to the vehicle using the at least one mounting feature with the at least one bi-stable flat spring in the metastable flat state; and
applying a threshold force to the at least one bi-stable flat spring and causing the at least one bi-stable flat spring to transition from the metastable flat state to the stable coiled state while encircling the at least one linear element.

19. The method of claim 18, further comprising the step of:
arranging at least one secondary locking feature to selectively lock the bi-stable flat spring in the stable coiled state, the at least one secondary locking feature being at least one of:
a tab or clip;
at least one interlocking edge;
at least one saw-tooth edge;
at least one friction element;
at least one patch of hook and loop fastener; and
at least one interlocking surface feature.

20. The method of claim 18, further comprising the step of:
arranging at least one flat state retaining feature to initially maintain the bi-stable flat spring in the metastable flat state; the at least one flat state retaining feature being at least one of:
a release pin;
an overmolded frangible feature; and
a peel-away feature.
